(19) United States
(12) Patent Application Publication
(10) Pub. No.: US 2010/0149209 A1
(43) Pub. Date: Jun. 17, 2010

(54) DISPLAY DEVICE AND METHOD OF DRIVING THE SAME

(75) Inventor: Masaki Nose, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/709,107

(22) Filed: Feb. 19, 2010

Related U.S. Application Data
(63) Continuation of application No. PCT/JP2007/067414, filed on Sep. 6, 2007.

(51) Int. Cl. G09G 5/00

(52) U.S. Cl. 345/618; 345/214

(57) ABSTRACT

The invention provides a display device and a method of driving the same in which degradation of display quality attributable to image sticking can be prevented while maintaining a memorized state of display. The display device includes a display section displaying a memorized display image which is kept displayed without electric power, a correction data generating section generating correction data for correcting a display characteristic of the display section which has changed due to sticking of the memorized display image, a corrected image data generating section generating corrected image data by correcting image data of a next image to be displayed next on the display section using the correction data, and a control section causing the display section to display the next image according to the corrected image data.

This application is a continuation of International Application No. PCT/JP2007/067414, filed Sep. 6, 2007.

### BACKGROUND OF THE INVENTION

1. Field of the Invention

The present invention relates to a display device capable of retaining a state of a displayed image without electric power and a method of driving the display device.

2. Description of the Related Art

Recently, various enterprises and universities are actively engaged in the development of electronic paper. The most promising application of electronic paper is electronic books, and other proposed applications include various types of portable apparatus such as sub-displays of mobile terminal apparatus and display sections of IC cards. One of advantageous display methods for electronic paper is the use of a display element utilizing a liquid crystal composition (cholesteric liquid crystal) in which a cholesteric phase is formed. A cholesteric liquid crystal has excellent features such as semi-permanent display retention characteristics (memory characteristics), vivid color display characteristics, high contrast characteristics, and high resolution characteristics.

A cholesteric liquid crystal has bi-stability (memory characteristics), and the liquid crystal can be put in any of a planar state, a focal conic state, or an intermediate state which is a mixture of the planar state and the focal conic state by adjusting the intensity of an electric field applied to the same. Once the liquid crystal enters the planar state or the focal conic state, the state is thereafter kept with stability even when no electric power is supplied.

The planar state can be obtained by applying a predetermined high voltage to a liquid crystal to apply a strong electric field to the same and thereafter nullifying the electric field abruptly. For example, the focal conic state can be obtained by applying a predetermined voltage lower than the above-described high voltage to the liquid crystal to apply an electric field to the same and thereafter nullifying the electric field abruptly. The intermediate state that is a mixture of the planar state and the focal conic state can be obtained by, for example, applying a voltage lower than the voltage for obtaining the focal conic state to the liquid crystal to apply an electric field to the same and thereafter nullifying the electric field abruptly.

A liquid crystal display element capable of full-color display utilizing cholesteric liquid crystals has a structure in which blue (B) display portion, a green (G) display portion, and a red (R) display portion are formed one over another in the order listed from the side of the element where a display surface is provided.

A display principle of a liquid crystal display element utilizing cholesteric liquid crystals will now be described with reference to FIGS. 19A and 19B using a B display portion 146b as an example. FIG. 19A shows alignment of cholesteric liquid crystal molecules 133 in a B liquid crystal layer 143b of the B display portion 146b observed when the layer is in the planar state. FIG. 19B shows alignment of the cholesteric liquid crystal molecules 133 in the B liquid crystal layer 143b of the B display portion 146b observed when the layer is in the focal conic state.

As shown in FIG. 19A, in the planar state, the liquid crystal molecules 133 are sequentially rotated in the thickness direction of substrates of the element to form helical structures, and helical axes of the helical structures are substantially perpendicular to substrate surfaces. In the planar state, incident light L having predetermined wavelengths in accordance with the helical pitch of the liquid crystal molecules are selectively reflected by the liquid crystal layer. A wavelength λ at which maximum reflection takes place is given by λ=n·p where n represents the average refractive index of a liquid crystal layer and p represents the helical pitch of the same.

Therefore, in order to allow blue light to be selectively reflected by the B liquid crystal layer 143b of the B display portion 146b in the planar state, the average refractive index n and the helical pitch p are determined, for example, such that an equation “λ=480 nm” holds true. The average refractive index n can be adjusted by selecting the liquid crystal material and the chiral material appropriately, and the helical pitch p can be adjusted by adjusting the chiral material content.

As shown in FIG. 19B, in the focal conic state, the liquid crystal molecules 133 are sequentially rotated in an in-plane direction of the substrates to form helical structures, and helical axes of the helical structures are substantially parallel to the substrate surfaces. In the focal conic state, the B liquid crystal layer 143b loses the selectivity of wavelengths to be reflected, and most of incident light L is transmitted by the layer. Since the transmitted light is absorbed by a light absorbing layer disposed on a back surface of a bottom substrate of the R display portion, a dark state (black) can be displayed.

As thus described, the reflection and transmission of incident light L can be controlled by a helically twisted state of alignment of the liquid crystal molecules 133. Cholesteric liquid crystals selectively reflecting green and red light rays in the planar state are enclosed in the G liquid crystal layer and the R liquid crystal layer, respectively, just as done in the B liquid crystal layer 143b to fabricate a display section capable of full-color display.

FIG. 20 shows examples of reflection spectra observed at the liquid crystal layers in the planar state. Wavelengths (in nanometers) of reflected light are shown along the horizontal axis, and reflectances (in comparison to that of a white plate (in percents)) are shown along the vertical axis. The reflection spectrum observed at the B liquid crystal layer 143b is represented by the curve connecting the triangular symbols. Similarly, the reflection spectrum observed at the G liquid crystal layer is represented by the curve connecting the square symbols, and the reflection spectrum observed at the R liquid crystal layer is represented by the curve connecting the rhombic symbols.

As shown in FIG. 20, the center wavelengths of the reflection spectra of the respective liquid crystal layers in the planar state get longer in the stated order B, G, and R. Therefore, the helical pitches of the cholesteric liquid crystals get longer in the stated order of the B, G, and R liquid crystal layers. Therefore, the chiral material contents of the cholesteric liquid crystals in the B, G, and R liquid crystal layers must get lower in the stated order of the B, G, and R liquid crystal layers.

In general, liquid crystal molecules of a cholesteric liquid crystal must be twisted stronger to achieve a shorter helical pitch, the shorter the wavelengths to be reflected. Therefore, the chiral material content of the liquid crystal is increased. Further, a higher chiral material content tends to result in a need for a higher driving voltage, in general. The reflection bandwidth Δλ of a cholesteric liquid crystal becomes greater, the greater the refractive index anisotropy Δn of the liquid crystal.

A liquid crystal display element utilizing cholesteric liquid crystals have the property of memorizing a display state. Specifically, the element is capable of displaying an image using the memory by semi-permanently holding a display state of the image even when no electric power is supplied. The element is therefore suitable for applications such as displaying an unchanging memorized image for a long time. However, when an image which has been displayed for a long time by such a liquid crystal display element is rewritten into a next image, the operation has resulted in the problem of so-called image sticking or a phenomenon in which the previous image remains as a faint after image.

Possible causes of image sticking include moisture, ionic impurities or affinity between a liquid crystal and substrate interfaces. In order to prevent image sticking, very high stability must be achieved in the degree of refinement of a liquid crystal material, the state of interfaces, and the like.

A method of mitigating image sticking as thus described has been proposed as follows. A timer and an optical sensor are provided to measure and detect elapsed time and the brightness of the environment of a screen, and the screen is put in a standby state (the display is turned off) depending on detection results to prevent image sticking.

It is understood that a cholesteric liquid crystal is subjected to a higher degree of image sticking, the higher the ambient temperature of the same. Another method has been proposed as follows based on this understanding. The ambient temperature of a liquid crystal display element is acquired. When a temperature increase or temperature change in unit time greater than a predetermined value is detected, image sticking is prevented by putting the screen in a standby state or displaying an image sticking preventing pattern using the focal conic state in which the entire screen is rendered black (for example, see JP-A-2004-219715).

Another proposed approach to the prevention of image sticking is as follows. While an image is displayed in a memorized display mode, refreshing (rewriting) is carried out each time a predetermined time interval passes by executing a sequence of applying a voltage to the cholesteric liquid crystal to align the cholesteric liquid crystal substantially parallel to the voltage applying direction and thereafter re-displaying the image which has been displayed. Such proposals include, for example, a method of preventing image sticking in a memory type liquid crystal display device by performing refreshing each time a predetermined time interval passes, the memory type liquid crystal display device including a monochromatic display having a plurality of columns formed by seven segments and having a separate common electrode provided for each column (for example, see JP-A-2002-139746).

Patent Document 1: JP-A-2004-219715

Patent Document 2: JP-A-2002-139746

### SUMMARY OF THE INVENTION

In the case of the methods of preventing image sticking by setting a display screen in a standby state or displaying an image sticking prevention pattern on a display screen, a memorized display state must be once terminated to execute such methods. As a result, the liquid crystal display element needs a long time to recover from the standby state or the state of displaying an image sticking prevention pattern and to display the image which has been displayed in the memorized state of display again. This is inconvenient for the user of the liquid crystal display element in situations such as when the user needs to view the image immediately.

In the case of the method of preventing image sticking by carrying out refreshing by temporarily interrupting a memorized state of display each time a predetermined time interval passes, the liquid crystal display element of interest will consume electric power for the refreshing operation. Further, the display of an image may be interrupted by the refreshing operation while the user of the liquid crystal display element is viewing the screen, which can be uncomfortable for the user.

It is an object of the invention to provide a display device and a driving method for the same which allow degradation of display quality attributable to image sticking to be prevented while maintaining a memorized state of display.

The above-described object is achieved by a display device including a display section displaying a memorized display image which is kept displayed without electric power, a correction data generating section generating correction data for correcting a display characteristic of the display section which has changed due to sticking of the memorized display image, a corrected image data generating section generating corrected image data by correcting image data of a next image to be displayed next on the display section using the correction data, and a display control section causing the display section to display the next image according to the corrected image data.

The above-described object is achieved by the method of driving a display device including the steps of, displaying a memorized display image which is kept displayed on the display section without electric power, generating correction data for correcting a display characteristic of the display section which has changed due to sticking of the memorized display image, generating corrected image data by correcting image data of a next image to be displayed next on the display section using the correction data, and displaying the next image on the display section according to the corrected image data.

The invention makes it possible to provide a display device allows degradation of display quality attributable to image sticking to be prevented while maintaining a memorized state of display.

### BRIEF DESCRIPTION OF THE DRAWINGS

FIG. 1A is a schematic illustration of a display section having an image displayed thereon, and FIG. 1B is a schematic illustration of a rewritten image having image sticking thereon;

FIG. 2 is a graph showing pulse response of pixels displayed in the planar state and pixels displayed in the focal conic state;

FIG. 3 is a graph showing a relationship between display day counts and degrees of image sticking;

FIG. 4 is a graph showing changes in gamma characteristics at various gray levels;

FIG. 5 is a graph showing a relationship between numbers of days elapsed and gamma values of a pixel, the numbers of days elapsed being counted after the pixel is rewritten to display images of various gray levels from a memorized state of display in which a white image has been displayed for a long time with the cholesteric liquid crystal set in a planar state;

FIG. 6 is a graph showing a relationship between numbers of days elapsed and gamma values of a pixel, the numbers of days elapsed being counted after the pixel is rewritten to display images of various gray levels from a memorized state of display in which a black image has been displayed for a long time with the cholesteric liquid crystal set in a focal conic state;

FIG. 7 is a graph showing a relationship between numbers of days elapsed and gamma values of a pixel, the numbers of days elapsed being counted after the pixel is rewritten to display images of various gray levels from a memorized state of display in which an image of an intermediate gray level has been displayed for a long time with the cholesteric liquid crystal set in an intermediate state;

FIG. 8 is a graph schematically representing a difference in pulse response as a difference in gamma characteristics;

FIG. 9 is a graph schematically showing correction values for correcting gamma characteristics which have changed due to image sticking;

FIG. 10 is a graph schematically showing results of the correction of gamma characteristics for correcting changes attributable to image sticking;

FIG. 11A is an illustration showing a memorized display image;

FIG. 11B is an illustration showing an image to be displayed next;

FIG. 11C is an illustration showing an actual state of display of the next image on the display screen;

FIG. 12A is an illustration showing a memorized display image;

FIG. 12B is an illustration showing an image to be displayed next;

FIG. 12C is an illustration showing a corrected image to be displayed next;

FIG. 12D is an illustration showing a state of display of the corrected next image on the display screen;

FIG. 13 is a block diagram showing a schematic configuration of a liquid crystal display element;

FIG. 14 is a schematic sectional view of the liquid crystal display element;

FIG. 15 is a graph showing an example of voltage-reflectance characteristics of a cholesteric liquid crystal;

FIGS. 16A and 16B show examples of waveforms of voltages applied to a liquid crystal layer of a pixel during one selection period;

FIG. 17 is a flow chart for explaining a display processing operation of the liquid crystal display element involving a gamma correction process;

FIG. 18 schematically shows a gamma correction process performed on images;

FIG. 19A is an illustration showing alignment of liquid crystal molecules of the cholesteric liquid crystal in a B liquid crystal layer of a B display portion observed when the layer is in the planar state;

FIG. 19B is an illustration showing alignment of liquid crystal molecules of the cholesteric liquid crystal in the B liquid crystal layer of the B display portion observed when the layer is in the focal conic state; and

FIG. 20 is a graph showing examples of reflection spectra observed at liquid crystal layers in the planar state.

### DESCRIPTION OF THE PREFERRED EMBODIMENTS

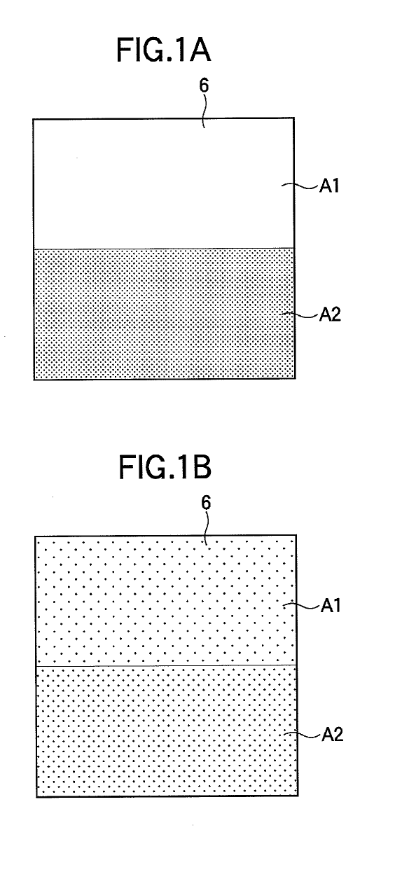

Basic principles of a display device and a driving method according to an embodiment of the invention will now be described with reference to FIGS. 1A to 12D.

FIG. 1A schematically shows a state of the apparatus in which an image is displayed on a display section 6 thereof. FIG. 1B schematically shows a state of the apparatus in which the image shown in FIG. 1A displayed on the display section 6 is rewritten into another image. As shown in FIG. 1A, a cholesteric liquid crystal in an area A1 constituting the top half of the display screen is put in the planar state to display white, and a cholesteric liquid crystal in an area A2 constituting the bottom half of the display screen is put in the focal conic state to display black. Next, the supply of a voltage to the display section 6 is stopped to put in a non-powered state. Even in the non-powered state, the display section 6 retains the images initially displayed thereon. That is, a white image and a black image are kept displayed in the areas A1 and A2, respectively, as memorized images. After such a memorized display state is maintained for a few days or a few weeks, for example, a next image in a uniform intermediate gray level is displayed on the entire display screen. Then, as shown in FIG. 1B, the image is displayed darker in the area A2 than in the area A1. That is, the previously displayed image is retained in the areas A1 and A2 to leave an after image. Display characteristics of the display section 6 change because of such image sticking, which results in a difference in gamma characteristics between the areas A1 and A2.

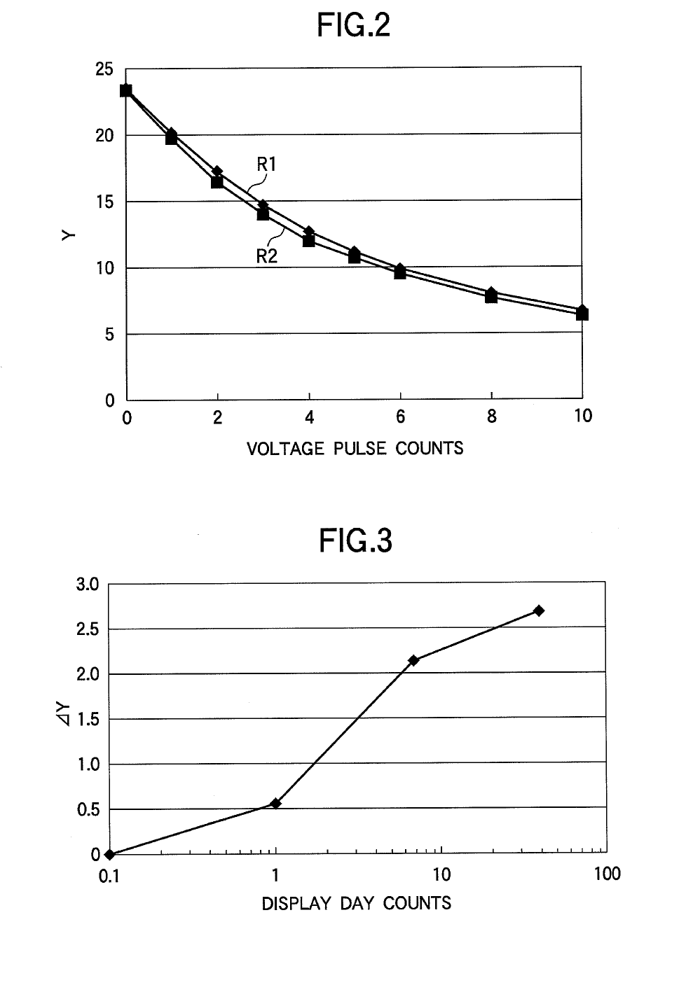

FIG. 2 is a graph showing pulse response of pixels displayed in the planar state and pixels displayed in the focal conic state. In FIG. 2, voltage pulse counts are shown along the horizontal axis, and brightness values Y are shown along the vertical axis. In FIG. 2, the curve R1 connecting the rhombic symbols represents pulse response of the pixels in the area A1 shown in FIG. 1A, and the curve R2 connecting the square symbols represents pulse response of the pixels in the area A2 shown in FIG. 1A.

Referring to FIG. 2, a transition from the planar state to the focal conic state is caused stepwise, for example, by applying pulses having pulse widths smaller than those of voltage pulses applied to the display section 6 in a normal driving mode. As shown in FIG. 2, the brightness of the area A2 displayed in the focal conic state is generally shifted toward the darker side compared to the brightness of the area A1 displayed in the planar state when the same pulse voltage is applied to the two areas A1 and A2.

FIG. 3 is a graph showing a relationship between display day counts and degrees of image sticking. In FIG. 3, counts of consecutive days during which images are kept displayed without electric power are logarithmically shown along the horizontal axis, and differences ΔY between the brightness values Y of the areas A1 and A2 shown in FIG. 1B are shown along the vertical axis. A difference value ΔY indicates a greater shift of the brightness of the area A2 toward the darker side, the greater the value. That is, a greater difference value indicates a more significant after image attributable to the sticking of the previously displayed image, i.e., a higher degree of image sticking. As shown in FIG. 3, image sticking occurs at a higher degree, the greater the number of consecutive days during which an image is continuously displayed.

As thus described, display characteristics are changed by image sticking, and a gray level curve itself can be changed. A description on a gray level curve will be made below by describing changes in gamma characteristics which are one of quantitative indices of the same, by way of example.

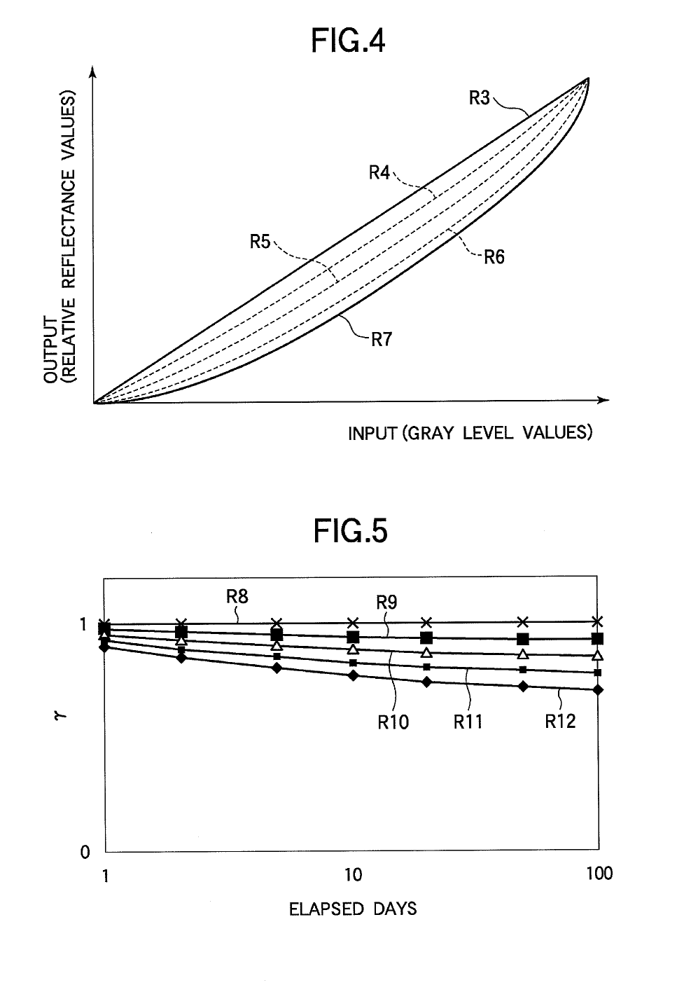

FIG. 4 is a graph showing changes in gamma characteristics (image sticking) occurring at various gray level values. In FIG. 4, inputs (gray level values) are shown along the horizontal axis, and outputs (relative reflectance values) are shown along the vertical axis. The curve R3 represents gamma characteristics observed when images of gray level values 0 to 15 are displayed at a pixel at which white has been displayed for a long time by applying a voltage associated with the planar state to the cholesteric liquid crystal of interest. The white image corresponds to gray level 15. The curve R4 represents gamma characteristics observed when images of gray level values 0 to 15 are displayed at a pixel at which an intermediate gray level has been displayed for a long time by applying a voltage associated with gray level 11 to the cholesteric liquid crystal. The curve R5 represents gamma characteristics observed when images of gray level values 0 to 15 are displayed at a pixel at which an intermediate gray level has been displayed for a long time by applying a voltage associated with the gray level 7 to the cholesteric liquid crystal. The curve R6 represents gamma characteristics observed when images of gray level values 0 to 15 are displayed at a pixel at which an intermediate gray level has been displayed for a long time by applying a voltage associated with gray level 3 to the cholesteric liquid crystal. The curve R7 represents gamma characteristics observed when images of gray level values 0 to 15 are displayed at a pixel at which black has been displayed for a long time by applying a voltage associated with the focal conic state to the cholesteric liquid crystal. The black image corresponds to gray level 0. The curves R4, R5, and R6 representing gamma characteristics obtained when intermediate gray levels are displayed for a long time are plotted in the order listed between the curves R3 and R7. In FIG. 4, the gamma characteristics obtained when displaying the image (white) of gray level 15 serve as a reference (γ=1) for specifying the gamma characteristics obtained when displaying the images of other gray level values. As shown in FIG. 4, when compared to the gamma characteristics of the pixel displayed for a long time in the planar state, the gamma value of a pixel undergoes changes in greater amounts, the lower the gray level at which the pixel is displayed for a long time. Therefore, the gamma value of the pixel displayed in the focal conic state undergoes significant degrees of reduction. An intermediate gray level is a mixture of the planar state and the focal conic state. Therefore, degrees of reduction in the gamma value of such an intermediate gray level reside between degrees of reduction in the gamma values of the pixel displayed in the planar state and the pixel displayed in the focal conic state.

FIG. 5 is a graph showing a relationship between gamma values of a pixel and numbers of days elapsed after the pixel is rewritten to display images of various gray levels from a memorized state of display in which a white image has been displayed for a long time with the cholesteric liquid crystal set in the planar state. In FIG. 5, the numbers of elapsed days are shown along the horizontal axis, and the gamma values are shown along the vertical axis. It is assumed that the pixel has a gamma value of 1 in a fully planar state and a gamma value of 0 in a fully focal conic state.

FIG. 5 shows results obtained by displaying images of gray level values 0 to 15 where gray level 0 represents the gray level of black displayed when the cholesteric liquid crystal is in the focal conic state and where the gray level value 15 represents the gray level of white displayed when the cholesteric liquid crystal is in the planar state. Specifically, FIG. 5 shows a curve R8 representing characteristics observed at gray level 15, a curve R9 representing characteristics observed at gray level 11, a curve R10 representing characteristics observed at gray level 7, a curve R11 representing characteristics observed at gray level 3, and a curve R12 representing characteristics observed at gray level 0 in the order listed in the top-to-bottom direction. As shown in FIG. 5, the gamma value at a gray level is closer to the value of white (gray level 15) which has been previously displayed as an image in the memorized state of display, the greater the gray level value is. The gamma value at each gray level is closer to the value in the planar state, the smaller the number of days elapsed after the image is rewritten. The gamma value characteristics shown in FIG. 5 are merely examples, and the amount of a change in a gamma value significantly depends on the liquid crystal material and panel structure employed in the display section 6.

FIG. 5 indicates that the gamma value of an image undergoes more significant reductions as days pass, the darker the image, i.e., the closer the image to the image in the focal conic state. It is also apparent that a pixel displaying an image of an intermediate gray level undergoes lower degrees of reduction in its gamma value compared to the dark image in the focal conic state.

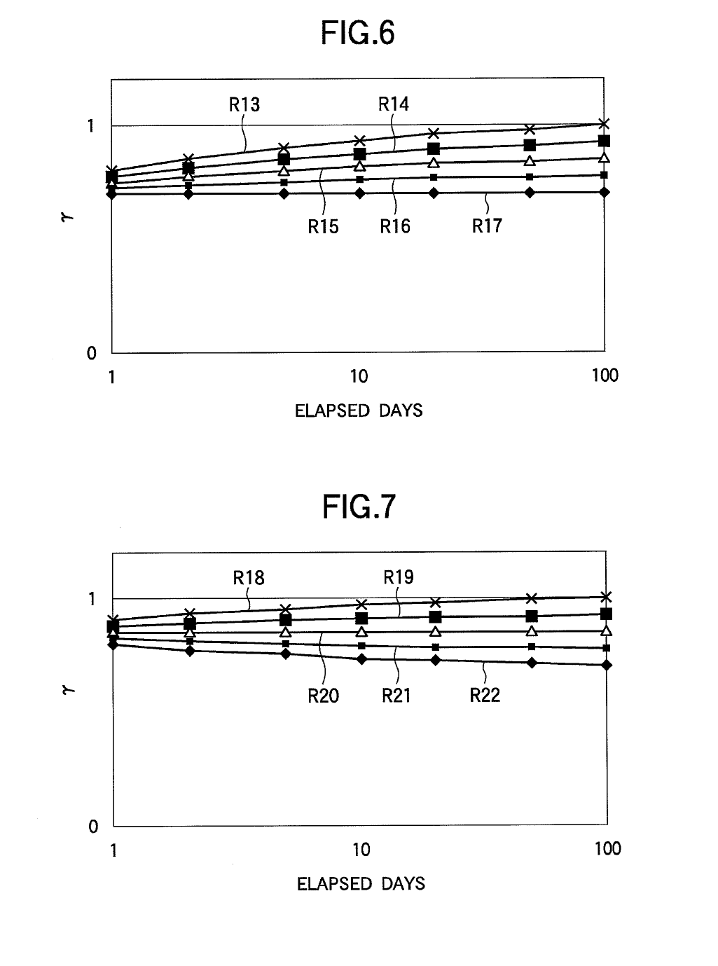

FIG. 6 is a graph showing a relationship between gamma values of a pixel and numbers of days elapsed after the pixel is rewritten to display images of various gray levels from a memorized state of display in which a black image has been displayed for a long time with the cholesteric liquid crystal set in the focal conic state. FIG. 6 shows the numbers of elapsed days along the horizontal axis and the gamma values along the vertical axis, in the same way as in FIG. 5. It is assumed that the pixel has a gamma value of 1 in a fully planar state and a gamma value of 0 in a fully focal conic state.

Similarly to FIG. 5, FIG. 6 shows results obtained by displaying images of gray level values 0 to 15 where gray level 0 represents the gray level of black displayed when the cholesteric liquid crystal is in the focal conic state and where the gray level value 15 represents the gray level of white displayed when the cholesteric liquid crystal is in the planar state. Specifically, FIG. 6 shows a curve R13 representing characteristics observed at gray level 15, a curve R14 representing characteristics observed at gray level 11, a curve R15 representing characteristics observed at gray level 7, a curve R16 representing characteristics observed at gray level 3, and a curve R17 representing characteristics observed at gray level 0 in the order listed in the top-to-bottom direction. As shown in FIG. 6, the gamma value at a gray level is closer to the value of white (gray level 15) which has been previously displayed as an image in the memorized state of display, the greater the gray level value is. The gamma value at each gray level is closer to the gamma value in the focal conic state, the smaller the number of days elapsed after the image is rewritten. The amount of a change in a gamma value significantly depends on the liquid crystal material and panel structure employed in the display section 6.

FIG. 6 indicates that the gamma value of an image undergoes more significant increases as days pass, the brighter the image, i.e., the closer the image to the image in the planar state. It is also apparent that a pixel displaying an image of an intermediate gray level undergoes higher degrees of increase in its gamma value compared to the dark image in the focal conic state.

FIG. 7 is a graph showing a relationship between gamma values of a pixel and numbers of days elapsed after the pixel is rewritten to display images of various gray levels from a memorized state of display in which an image of an intermediate gray level has been displayed for a long time with the cholesteric liquid crystal set in the intermediate state. FIG. 7 shows the numbers of elapsed days along the horizontal axis and the gamma values along the vertical axis, in the same way as in FIGS. 5 and 6. It is assumed that the pixel has a gamma value of 1 in a fully planar state and a gamma value of 0 in a fully focal conic state.

Similarly to FIGS. 5 and 6, FIG. 7 shows results obtained by displaying images of gray level values 0 to 15 where gray level 0 represents the gray level of black displayed when the cholesteric liquid crystal is in the focal conic state and where the gray level value 15 represents the gray level of white displayed when the cholesteric liquid crystal is in the planar state. Specifically, FIG. 7 shows a curve R18 representing characteristics observed at gray level 15, a curve R19 representing characteristics observed at gray level 11, a curve R20 representing characteristics observed at gray level 7, a curve R21 representing characteristics observed at gray level 3, and a curve R22 representing characteristics observed at gray level 0 in the order listed in the top-to-bottom direction. As shown in FIG. 7, the gamma value at a gray level is closer to the value of white (gray level 15) which has been previously displayed as an image in the memorized state of display, the greater the gray level value is. The gamma value at each gray level is closer to the gamma value at the previously displayed intermediate gray level, the smaller the number of days elapsed after the image is rewritten. The amount of a change in a gamma value significantly depends on the liquid crystal material and panel structure employed in the display section 6.

FIG. 7 indicates that the gamma value of an image undergoes more significant increases as days pass, the brighter the image, i.e., the closer the image to the image in the planar state. It is also apparent that the gamma value of an image undergoes more significant reductions as days pass, the darker the image, i.e., the closer the image to the image in the focal conic state. Further, it is apparent that an image has a higher tendency to undergo a not so significant change in its gamma value regardless of the number of days elapsed after a rewrite of the same, the closer the image to the intermediate state.

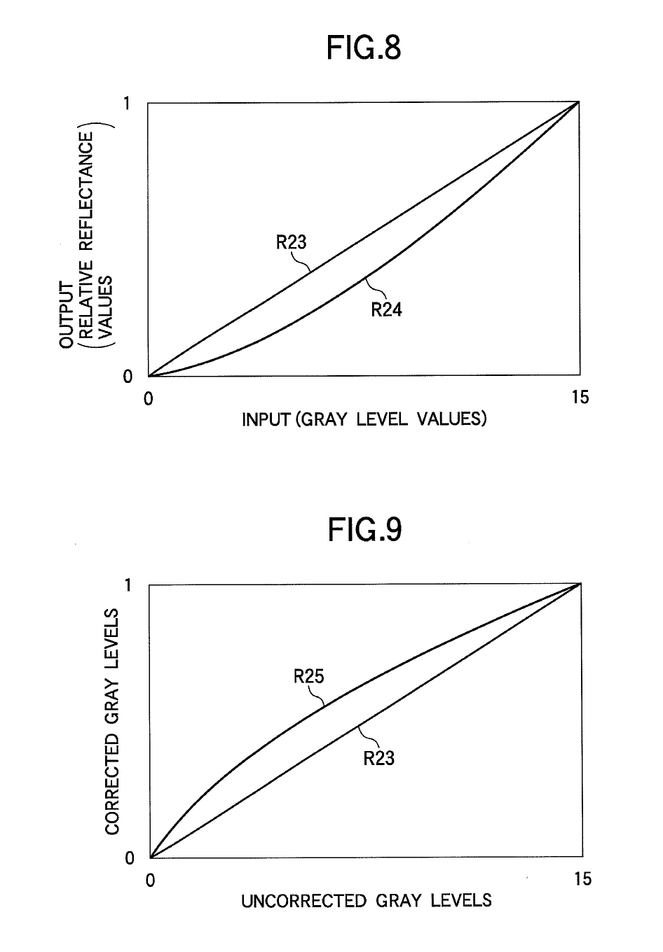

A description will now be made with reference to FIGS. 8 to 10 on a gamma correction process performed according to the embodiment on a screen having image sticking.

FIG. 8 schematically illustrates the difference in pulse response shown in FIG. 2 as a difference in gamma characteristics. In FIG. 8, inputs (gray level values) are shown along the horizontal axis, and outputs (relative reflectance values) along the vertical axis. In FIG. 8, the curve R23 represents gamma characteristics of the area A1, and the curve R24 represents gamma characteristics of the area A2. FIG. 8 is plotted based on the area A1 displayed in the planar state as shown in FIG. 1A.

An after image attributable to image sticking is generated on the display section 6. As apparent from FIG. 8, when compared to the curve R23 representing the gamma characteristics of the area A1, an output value on the curve R24 representing the gamma characteristics of the area A2 is smaller relative to the input associated therewith, the closer the input to the middle gray level. The curve R23 representing the area A1 and the curve R24 representing the area A2 meet each other substantially at gray levels 0 and 15 because the after image attributable to image sticking is hardly visible at those gray levels.

FIG. 9 schematically illustrates correction data for connecting gamma characteristics which have changed due to image sticking as shown in FIG. 8. In FIG. 9, uncorrected gray levels are shown along the horizontal axis, and corrected gray levels along the horizontal axis. In FIG. 9, the curve R23 represents the gamma characteristics of the area A1, and the curve R25 represents correction data for the gamma characteristics of the area A2.

FIG. 9 shows correction data calculated as the inverses of the gamma values shown in FIG. 8. The correction data is contrary to the gamma characteristics of the area A2 shown in FIG. 8 in that, when compared to the curve R23 representing the gamma characteristics of the area A1, a corrected gray level value on the curve R25 representing the gamma characteristics of the area A2 is greater relative to the uncorrected gray level value associated therewith, the closer the input to the middle gray level.

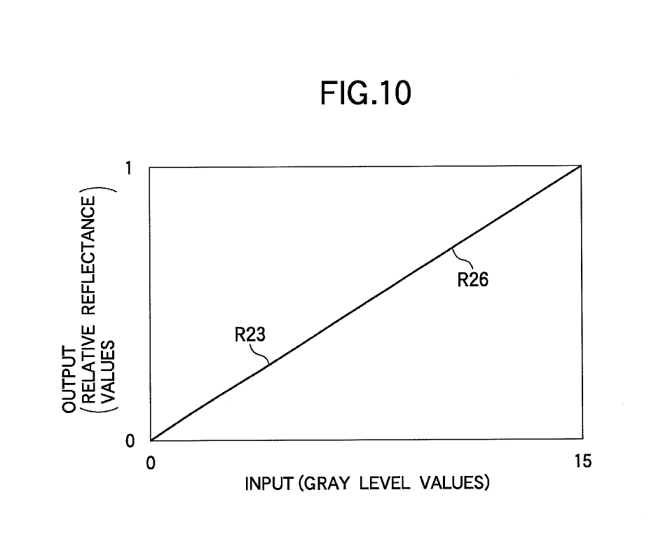

FIG. 10 schematically shows results of the correction made on the gamma characteristics which have changed due to image sticking. In FIG. 10, inputs (gray level values) are shown along the horizontal axis, and outputs (relative reflectance values) are shown along the vertical axis.

Referring to FIG. 10, the gamma characteristics shown in FIG. 8 are corrected based on the correction data shown in FIG. 9, and it will be understood that the difference in pulse response shown in FIG. 2 is eliminated. Specifically, inverse gamma correction that uses the inverses of the gamma values is carried out on the pixels in the area A2 displayed in the focal conic state. As a result, output display characteristics R23 of the area A1 and output display characteristics R26 of the area A2 coincide with each other as shown in FIG. 10, and the amounts of changes in display characteristics resulting from image sticking are canceled by correction data. Thus, the after image attributable to image sticking becomes invisible. In the present embodiment, the amounts of changes in display characteristics resulting from image sticking are canceled by correction data to correct the display characteristics of the next image to be displayed, and the generation of an after image attributable to image sticking can therefore be suppressed.

A method of driving the liquid crystal display element (display device) will now be briefly described by showing examples of images displayed on the display section 6.

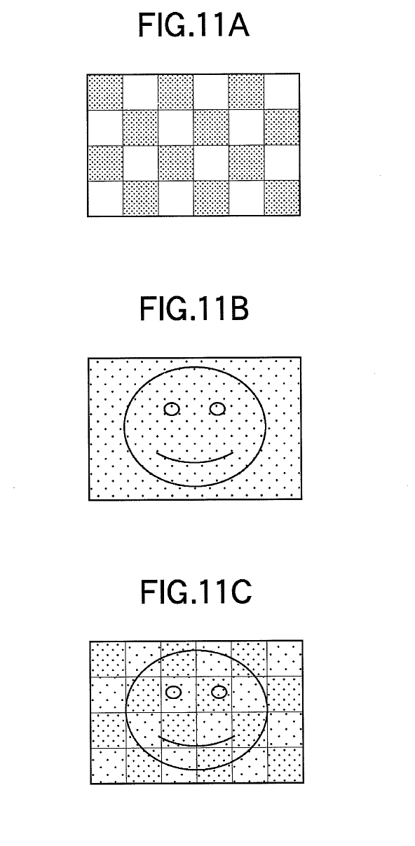

FIGS. 11A, 11B, and 11C are illustrations for explaining problems of a driving method of a liquid crystal display element according to the related art. FIG. 11A shows a memorized display image. FIG. 11B shows the next image to be displayed. FIG. 11C shows a state of the next image which is actually displayed on the display screen.

According to a driving method existing in the related art, for example, a black-and-white checkered pattern as shown in FIG. 11A is first displayed for a long time as a memorized display image without electric power utilizing the memory characteristics.

Next, as shown in FIG. 11B, a line graphic of a face is displayed in the middle of the screen on a background of an intermediate gray level which is midway between the maximum gray level and the minimum gray level. The black areas of the checkered pattern displayed for a long time in the memorized state of display have gamma characteristics similar to those of the area A2 represented by the curve R24 in FIG. 8, and the black areas are displayed on the display section as an after image attributable to image sticking. As a result, as shown in FIG. 11C, the image displayed after the memorized display image appears in a state which is a synthesis of the images shown in FIGS. 11A and 11B. Specifically, the background is not rendered in a uniform color, and the areas displayed in white in the previously displayed checkered pattern have a reflectance higher than that of the areas displayed in black in the previous image.

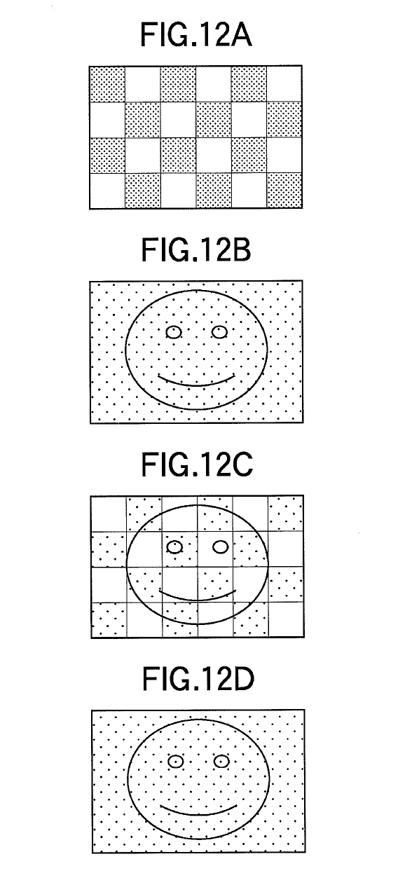

FIGS. 12A to 12D are illustrations for explaining a driving method according to the present embodiment. FIG. 12A shows a memorized display image. FIG. 12B shows the next image to be displayed. FIG. 12C shows an image based on corrected image data for correcting the next image. FIG. 12D is a state of the next image displayed on the display screen using the corrected image data.

According to the driving method of the present embodiment, for example, a black-and-white checkered pattern as shown in FIG. 12A is first displayed for a long time as a memorized display image without electric power utilizing the memory characteristics.

Next, as shown in FIG. 12B, a line graphic of a face is displayed in the middle of the screen on a background of an intermediate gray level which is midway between the maximum gray level and the minimum gray level.

When the next image is displayed based on image data of a face, gamma correction is performed on the next image to be displayed. As shown in FIG. 8, gamma correction is performed using white as a reference and on an assumption that a white area has a gamma value of 1. For example, it is predicted that the black areas will have gamma characteristics similar to those of the area A2 represented by the curve R24 in FIG. 8, and correction data is generated by obtaining the inverse of the gamma value of the area A2 according to the prediction as shown in the curve R25 of FIG. 9. Next, corrected image data is generated by correcting the image data of the next image using the correction data. The corrected image data are generated such that the face image will be synthesized with an image of the checkered pattern in which the shades of color are inverted from that in the original pattern, as shown in FIG. 12C. That is, the gray level of the black areas predicted to have a lower reflectance is corrected to a value higher than the original value.

Next, an image is displayed using the corrected image data. As a result, the black areas and white areas of the checkered pattern coincide with each other in gamma characteristics in the same way as in the results of gamma characteristics correction shown in FIG. 10. That is, the amount of a change in gamma characteristics attributable to image sticking is corrected. Thus, the driving method of the present embodiment makes it possible to display the face image with an after image of the checkered pattern attributable to image sticking eliminated or kept unnoticeable as shown in FIG. 12D.

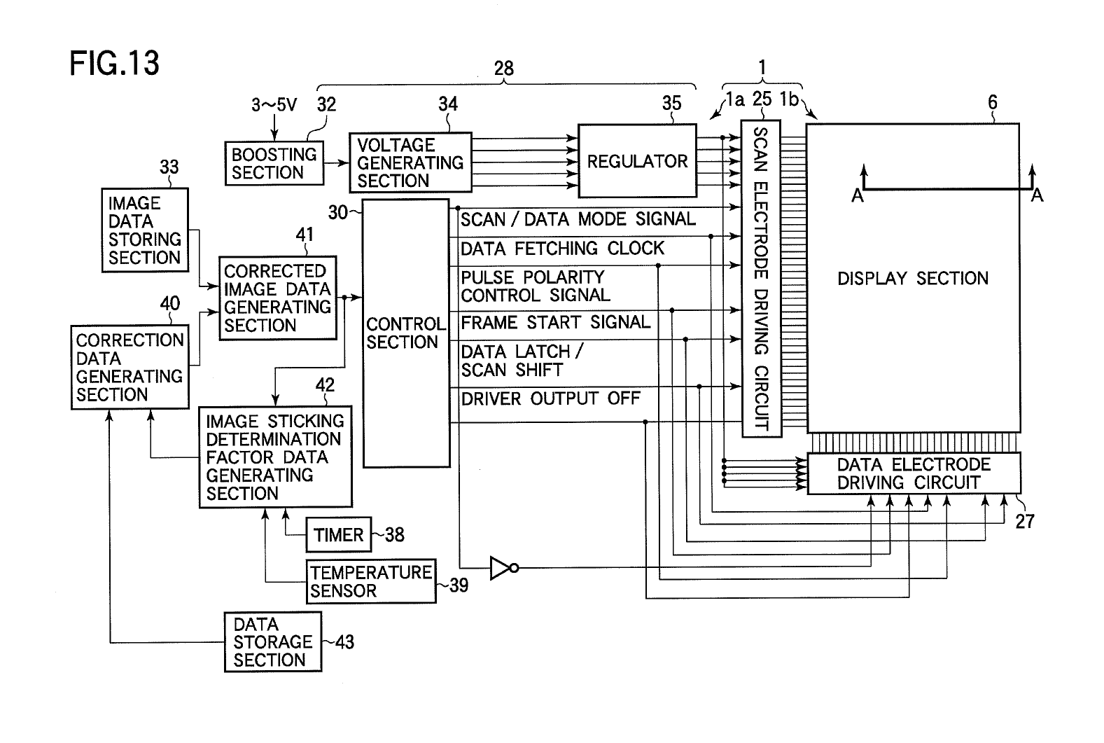

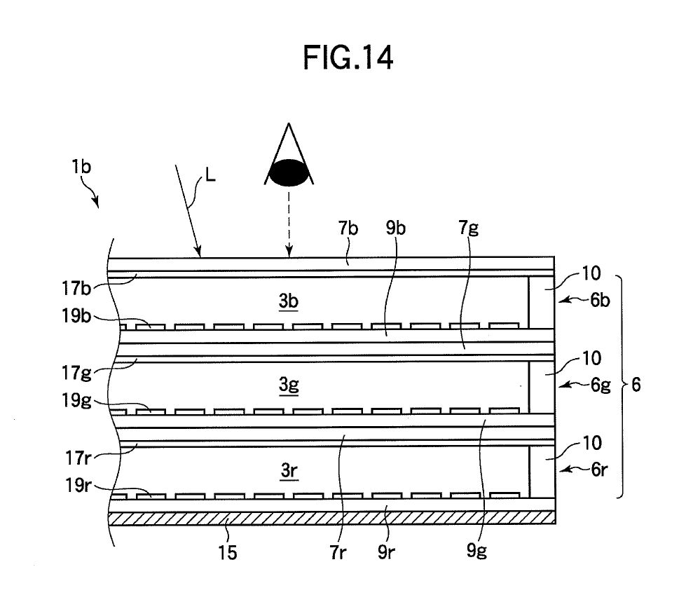

A liquid crystal display element according to the embodiment of the invention will now be described with reference to FIGS. 13 to 18. The present embodiment will be described as an application of the invention to a liquid crystal display element which utilizes cholesteric liquid crystals for blue (B), green (G), and red (R) forming a cholesteric phase and which is capable of memorized display for displaying an image as a memorized display image, by way of example. FIG. 13 is a block diagram showing a schematic configuration of the liquid crystal display element of the present embodiment. FIG. 14 is a schematic sectional view of a display section 6 taken along a straight line A-A extending in the horizontal direction of FIG. 13.

As shown in FIG. 13, a liquid crystal display element 1 includes a circuit block 1a and a display block 1b. The circuit block 1a includes a power supply section 28, an image data storing section 33, a timer section 38, a temperature sensor 39, a correction data generating section 40, a corrected image data generating section 41, an image sticking determination factor data generating section 42, a data storage section 43, and a control section (display control section) 30.

The display block 1b includes a display section 6, a scan electrode driving circuit (COM driver) 25, and a data electrode driving circuit (SEG driver) 27.

The power supply section 28 includes a boosting portion 32, a voltage generating portion 34, and a regulator 35. For example, the boosting portion 32 includes a DC-to-DC converter and boosts, for example, input voltages ranging from 3 V dc to 5 V dc into voltages ranging from about 10 V dc to about 40 V dc required for driving the display section 6.

The voltage generating portion 34 generals voltages at a plurality of required levels which determine the gray level of each pixel and whether each pixel is selected or not, using the voltages boosted by the boosting portion 32 and other voltage input to the same.

The regulator 35 includes a Zenner diode and an operational amplifier. The regulator 35 stabilizes the voltages generated by the voltage generating section 34 and supplies them to the scan electrode driving circuit 25 and the data electrode driving circuit 27 provided in the display block 1b.

The control section 30 includes a processor and controls the liquid crystal display element 1 as a whole. The control section 30 switches scan speeds and driving voltages of the display section 6 through the scan electrode driving circuit 25 and the data electrode driving circuit 27 to display images and also executes a process of resetting a display area.

The control section 30 outputs drive pulses to the display section 6 through the scan electrode driving circuit 25 and the data electrode driving circuit 27. As a result, voltages generated by the driving pulses are applied to the display section 6, whereby the control section 30 drives the display section 6.

The control section 30 controls the display section 6 in a line sequential driving mode in which scan electrodes 17b, 17g, and 17r (see FIG. 14) in the form of lines arranged at substantially equal intervals in the display section 6 are sequentially scanned. The scan speed of the scan electrode driving circuit 25 is changed by control exercised by the control section 30 to change an application time for applying a voltage generated by a drive pulse. At this time, the control section 30 controls the data electrode driving circuit 27 such that a predetermined voltage based on image data is output to the display section 6 in synchronism with scan timing of the scan electrode driving circuit 25.

The control section 30 outputs drive data generated by the same to the scan electrode driving circuit 25 and the data electrode driving circuit 27 in synchronism with a data reading clock signal. The control section 30 changes the scan speed of the scan electrode driving circuit 25 by outputting the drive data to the same. The control section 30 outputs control signals such as a scan/data mode signal, a frame start signal, a pulse polarity control signal, a data latch/scan shift signal, and a driver output turn-off signal to the scan electrode driving circuit 25 and the data electrode driving circuit 27.

The image data storing section 33 is stored image data input from a system and outputs the stored image data to the corrected image data generating section 41.

The timer 38 is a counter measuring a period. For example, the timer 38 measures an elapsed period since the display of a memorized display image on the display section 6 and outputs elapsed period data based on the elapsed period to the image sticking determination factor data generating section 42.

The temperature sensor 39 detects the temperature of the display portion 6 and outputs temperature data based on the detected temperature to the image sticking determination factor data generating section 42. The temperature sensor 39 may detect the temperature of the outer environment in which the display section 6 is situated and may output the detected outer environmental temperature to the image sticking determination factor data generating section 42 as the temperature of the display section 6.

For example, the image sticking determination factor data generating section 42 includes a RAM and detects image sticking determination factors associated with all pixels of the display section 6 at which an image is displayed. Image sticking determination factors used in the present embodiment include, for example, the period for which a memorized display image has been displayed in a memorized state, a record of temperatures of the display portion 6 when displaying the memorized display image, and gray levels of the memorized display image. The image sticking determination factor data generating section 42 acquires such image sticking determination factors from elapsed period data output by the timer 38, temperature data output by the temperature sensor 39, and corrected image data output by the corrected image data generating section 41. Based on the image sticking determination factors acquired as thus described, the image sticking determination factor data generating section 42 generates image sticking determination factor data associated with all pixels of the display section 6 and outputs the image sticking determination factor data thus generated to the correction data generating section 40.

For example, the data storage section 43 includes a ROM and stores characteristics data based on a degree of image sticking at the display section 6 predicted according to image sticking determination factors of an image displayed on the display section 6 in advance. For example, the characteristics data are data in which image sticking determination factors such as image display periods and gray levels are associated with amounts of changes in gamma values predicted according to the image sticking determination factors, i.e., degrees of image sticking. The amounts of changes in gamma characteristics also depend on the temperature of the display section 6. Therefore, the characteristics data are preferably generated in association with each of temperatures defined by dividing the temperature range from 0 to 50° C. by steps of 5° C. each. When the liquid crystal display element 1 has been just manufactured and shipped and no image has been displayed on the same, all pixels of the display section 6 are set at a gamma value of 1.

The characteristics data are generated in the form of an LUT (lookup table). The data storage section 43 outputs characteristic data to the correction data generating section 40 according to a request from the correction data generating section 40. It is preferable to generate characteristics data common to a plurality of display portions 6r, 6g, and 6b because the volume of required data can be kept small. However, when the display potions 6r, 6g, and 6b are significantly different from each other in characteristics, it is preferable to generate separate data for each of the display portions 6r, 6g, and 6b for the purpose of preventing image sticking.

The correction data generating section 40 generates correction data for correcting display characteristics, e.g., gamma characteristics, of image data output from the image data storing section 33 to the corrected image data generating section 41. The correction data generating section 40 acquires image sticking determination factor data from the image sticking determination factor data generating section 42. The characteristics data stored in the data storage section 43 are data in which image sticking determination factors obtained based on image sticking determination factor data to be used for determining the degree of image sticking of a memorized display image are associated with predicted values of degrees of image sticking. The correction data generating section 40 acquires a predicted value associated with an image sticking determination factor by referring to the characteristics data. The correction data generating section 40 calculates the amount of a change in the display characteristics of the display section 6 from the predicted value thus obtained. Thus, the correction data generating section 40 generates correction data for correcting the display characteristics of the display section 6 by cancelling the amount of the change in the display characteristics which has been caused by image sticking of a memorized display image. The correction data are generated in the form of an LUT as mapping data including correction values for gamma values associated with all pixels. The correction data generating section 40 outputs the correction data thus generated to the corrected image data generating section 41.

The corrected image data generating section 41 is a conversion circuit and acquires image data from the image data storing section 33 and acquires correction data from the correction data generating section 40. The corrected image generating section 41 corrects the image data of the next data to be displayed using the correction data and generates corrected image data by correcting display characteristics of the next image to be displayed such as gamma characteristics. For example, the corrected image data are generated such that the plurality of pixels formed at the display section 6 have substantially the same gamma characteristics. The corrected image data are generated prior to a gray level conversion process for converting the bit count of image data input from the system into bit counts associated with the scan electrode driving circuit 25 and the data electrode driving circuit 27. The correction data thus generated are output to the control section 30 and also output to the image sticking determination factor data generating section 42. The control section 30 causes the display section 6 to display the next image to be displayed using the corrected image data output from the corrected image data generating section 41. For example, the control section 30 generates drive data for driving the display section 6 based on corrected image data of the next image associated with each of the display portions 6r, 6g, and 6b forming the display section 6. Thus, the liquid crystal display element 1 can display an image without an after image attributable to image sticking on the display section 6 thereof as described above.

As shown in FIG. 14, the display section 6 includes a B display portion 6b having a B liquid crystal layer 3b reflecting blue light in the planar state, a G display portion 6g having a G liquid crystal layer 3g reflecting green light in the planar state, and an R display portion 6r having an R liquid crystal layer 3r reflecting red light in the planar state. The display section 6 is capable of memorized display in which an image is kept displayed without an electric power as a memorized display image. The B display portion 6b, the G display portion 6g, and the R display portion 6r are formed one over another in the order listed from the side of a display surface thereof through which light enters the element.

The B display portion 6b includes a pair of substrates, i.e., a top substrate 7b and a bottom substrate 9b disposed opposite to each other, a seal material 10 sealing the outer periphery of the gap between the substrates 7b and 9b, and the B liquid crystal layer 3b which is injected in the gap enclosed by the top substrate 7b, the bottom substrate 9b, and the seal material 10. The display surface is located on the side of the top substrate 7b. As indicated by the arrow in a solid line, incident light L impinges on the display surface from above the substrate 7b. FIG. 14 schematically shows an eye of a viewer and the viewing direction of the viewer (indicated by the arrow in a broken line) above the substrate 7b. The B liquid crystal layer 3b includes a cholesteric liquid crystal for blue having an average refractive index n and a helical pitch p adjusted to selectively reflect blue light.

The G display portion 6g includes a pair of substrates, i.e., a top substrate 7g and a bottom substrate 9g disposed opposite to each other and a G liquid crystal layer 3g enclosed between the substrates 7g and 9g. The G liquid crystal layer 3g includes a cholesteric liquid crystal for green having an average refractive index n and a helical pitch p adjusted to selectively reflect green light.

The R display portion 6r includes a pair of substrates, i.e., a top substrate 7r and a bottom substrate 9r disposed opposite to each other and an R liquid crystal layer 3r enclosed between the substrates 7r and 9r. The R liquid crystal layer 3r includes a cholesteric liquid crystal for red having an average refractive index n and a helical pitch p adjusted to selectively reflect red light. A light absorbing layer 15 is disposed on a back surface of the bottom substrate 9r.

The liquid crystal composition constituting each of the B, G, and R liquid crystal layers 3b, 3g, and 3r is a cholesteric liquid crystal obtained by adding a chiral material to a nematic liquid crystal mixture to a content of several tens percent by weight, e.g., 10 to 40 percent by weight. When a nematic liquid crystal includes a relatively great amount of chiral material, a cholesteric phase that is a great helical twist of liquid crystal molecules of nematic liquid crystal can be formed in the liquid crystal to cause interference reflection of the incident light L. A cholesteric liquid crystal is also referred to as “chiral nematic liquid crystal”. The chiral material content is a value based on an assumption that the total amount of the nematic liquid crystal component and the chiral material constitutes 100 percent by weight. Although various types of nematic liquid crystals known in the related art may be used, the cholesteric liquid crystal composition preferably has dielectric constant anisotropy Δ∈ satisfying 20≦Δ∈50. When the dielectric constant anisotropy Δ∈ is 20 or more, the chiral material to be used can be selected from a wide range of materials. When the dielectric constant anisotropy Δ∈ is excessively lower than the range, the driving voltages for the liquid crystal layers 3b, 3g, and 3r become too high. On the contrary, when the dielectric constant anisotropy Δ∈ is excessively higher than the range, the stability and reliability of the element as the display section 6 is degraded, and images defects and image noises become more likely to occur.

Refractive index anisotropy Δn of the cholesteric liquid crystals is an important physical property which dominates image quality. The cholesteric liquid crystals preferably have refractive index anisotropy Δn having a value satisfying 0.18≦Δn≦0.24. When the refractive index anisotropy Δn is smaller than the range, the liquid crystal layers 3b, 3g, and 3r have low reflectances in the planar state, and they will display a dark image having insufficient brightness. When the refractive index anisotropy Δn is greater than the range, the liquid crystal layers 3b, 3g, and 3r have significant scatter reflections in the focal conic state, and the display screen have insufficient color purity and contrast which results in a blurred image. Further, when the refractive index anisotropy Δn is greater than the range, the cholesteric liquid crystals have high viscosity, and the speed of response of the cholesteric liquid crystals reduces.

The cholesteric liquid crystals preferably have a specific resistance ρ satisfying 10¹⁰≦ρ≦10¹³ Ω·cm. The cholesteric liquid crystals preferably have the lower the viscosity since a voltage increase and degradation of contrast at a low temperature can be more effectively suppressed.

In the multi-layer structure formed by the display portions 6b, 6g, and 6r, the optical rotatory power of the G liquid crystal layer 3g is different from the optical rotatory power of the B and R liquid crystal layers 3b and 3r in the planar state. As a result, in the regions where overlaps exist between the blue and green reflectance spectra and between the green and red reflectance spectra, right-handed circularly polarized light can be reflected by the B liquid crystal layer 3b, and left-handed circularly polarized light can be reflected by the G liquid crystal layer 3g. Thus, loss of reflected light can be suppressed to improve the brightness of the display screen of the display section 6.

The top substrates 7b, 7g, and 7r and the bottom substrates 9b, 9g, and 9r must have translucency. In the present embodiment, pairs of glass substrates are used. Film substrates made of polycarbonate (PC) or polyethylene terephthalate (PET) may be used instead of glass substrates. In the present embodiment, all of the top substrates 7b, 7g, and 7r and the bottom substrates 9b, 9g, and 9r have translucency, but the bottom substrate 9r of the R display portion 6r disposed at the bottom of the element may be opaque.

A plurality of strip-like scan electrodes 17b extending in the horizontal direction of FIG. 14 are formed in parallel on the side of the top substrate 7b of the B display portion 6b facing the B liquid crystal layer 3b. A plurality of strip-like data electrodes 19b are formed in parallel on the side of the bottom substrate 9b facing the B liquid crystal layer 3b such that they extend substantially perpendicular to the scan electrodes 17b. In the present embodiment, a transparent electrode made of indium tin oxide (ITO) is patterned to form the plurality of scan electrodes 17b and the plurality of data electrodes 19b which are in the form of stripes. Although a typical material used to form the electrodes 17b and 19b is ITO, a transparent conductive film made of indium zinc oxide (IZO) may alternatively be used.

The electrodes 17b and 19b are disposed face-to-face so as to intersect each other when the top substrate 7b and the bottom substrate 9b are viewed in the normal direction of the surfaces on which the electrodes are formed. Each of the regions where the electrodes 17b and 19b intersect each other constitutes a pixel. A plurality of pixels are defined by the electrodes 17b and 19b and arranged in the form of a matrix to form a display surface.

Preferably, each of the electrodes 17b and 19b may be coated with a functional film, e.g., an insulation thin film or an alignment stabilizing film for stabilizing the alignment of liquid crystal molecules. The insulation thin film has the function of preventing shorting between the electrodes 17b and 19b, and the film also serves as a gas barrier layer having the function of improving the reliability of the display section 6. A polyimide resin or an acryl resin may be used as the alignment stabilizing film. In the present embodiment, for example, alignment stabilizing films are applied throughout the substrates to coat the electrodes 17b and 19b. The alignment stabilizing films may be also used as insulating thin films.

The B liquid crystal layer 3b is enclosed between the substrates 7b and 9b by a seal material 10 applied to the peripheries of the top substrate 7b and the bottom substrate 9b. The thickness (cell gap) of the B liquid crystal layer 3b must be kept uniform. In order to maintain a predetermined cell gap, spherical spacers made of a resin or inorganic oxide are dispersed in the B liquid crystal layer 3b. Alternatively, a plurality of columnar spacers coated with a thermoplastic resin on the surface thereof are formed in the B liquid crystal layer 3b. In the display section 6 of the present embodiment, spacers (not shown) are inserted in the B liquid crystal layer 3b to keep the cell gap uniform. Preferably, the B liquid crystal layer 3b has a cell gap d in a range satisfying 3 μm≦d≦6 μm.

The structure of the G display portion 6g and the R display portion 6r will not be described because it is similar to that of the B display portion 6b. A visible light absorbing layer 15 is provided on the outer surface (back surface) of the bottom substrate 9r of the R display portion 6r. Therefore, when all of the B, G, and R liquid crystal layers 3b, 3g, and 3r are in the focal conic state, black is displayed on the display surface of the display section 6. The visible light absorbing layer 15 may be provided as occasion demands.

A scan electrode driving circuit 25 (see FIG. 13) mounting scan electrode driver ICs for driving the plurality of scan electrodes 17b, 17g, and 17r separately is connected to the top substrates 7b, 7g, and 7r. A data electrode driving circuit 27 (see FIG. 13) mounting data electrode driver ICs for driving the plurality of data electrodes 19b, 19g, and 19r separately is connected to the bottom substrates 9b, 9g, and 9r. The driving circuits 25 and 27 generate driving pulses including pulse-like scan signals and data signals based on drive data output from the control section 30 and voltages supplied from the regulator 35. The driving circuits 25 and 27 are provided to output driving pulses thus generated to predetermined scan electrodes 17b, 17g, and 17r and data electrodes 19b, 19g, and 19r, respectively.

Electronic paper is formed by providing the liquid crystal display element 1 with an input/output device and a control device for exercising overall control of the element (neither of the devices is shown). The electronic paper may be used as a display device of an electronic terminal apparatus. Such an electronic terminal apparatus may be used as a display device of a display system.

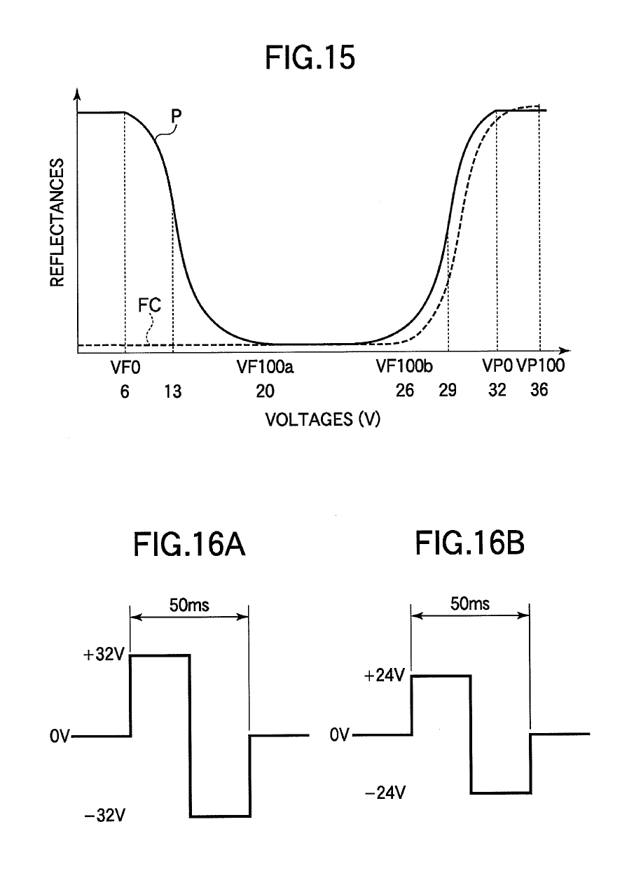

FIG. 15 is a graph showing an example of voltage-reflectance characteristics of a cholesteric liquid crystal. Voltage values (V) applied to the cholesteric liquid crystal are shown along the horizontal axis, and reflectances (%) of the cholesteric liquid crystal are shown along the vertical axis. The curve P in a solid line shown in FIG. 15 represents voltage-reflectance characteristics observed when the cholesteric liquid crystal is initially in the planar state, and the curve FC in a broken line represents voltage-reflectance characteristics observed when the cholesteric liquid crystal is initially in the focal conic state.

FIG. 16A shows an example of an effective pulse applied to the liquid crystal layers 3b, 3g, and 3r of a pixel to be driven into the planar state, and FIG. 16B shows an example of a waveform of a voltage applied to the liquid crystal layers 3b, 3g, and 3r of a pixel to be driven into the focal conic state. These effective pulses are applied by the scan electrode driving circuit 25 and the data electrode driving circuit 27.

At the pixel to be driven into the planar state, as shown in FIG. 16A, the scan electrode driving circuit 25 and the data electrode driving circuit 27 apply a voltage of +32 V to the liquid crystal layers 3b, 3g, and 3r of the pixel to generate a strong electric field in the liquid crystal layers 3b, 3g, and 3r. Then, the helical structure of the liquid crystal molecules is completely decomposed into a homeotropic state in which the longitudinal axes of all liquid crystal molecules follow the direction of the electric field. When the electric field is thereafter abruptly removed from the liquid crystal in the homeotropic state, the helical axes of the liquid crystals becomes perpendicular to the surfaces of the electrodes, and the liquid crystals therefore enter the planar state in which light rays having wavelengths in accordance with the helical pitch of the liquid crystals are selectively reflected. Specifically, the liquid crystal layers 3b, 3g, and 3r enter the planar state when a pulse voltage of ±32 V (≈VP0) is applied to them, and the pixel enters a bright state.

At the pixel to be driven into the focal conic state, as shown in FIG. 16B, the scan electrode driving circuit 25 and the data electrode driving circuit 27 apply a voltage of +24 V to the liquid crystal layers 3b, 3g, and 3r of the pixel to generate a relatively weak electric field in the liquid crystal layers 3b, 3g, and 3r such that the helical structure of the liquid crystal molecules will not be completely decomposed, and the electric field is thereafter removed. Alternatively, a strong electric field may be generated in the liquid crystal layers 3b, 3g, and 3r, and the electric field may be slowly removed. Then, the helical axes of the liquid crystals become parallel to the electrode surfaces, and the liquid crystals therefore enter the focal conic state in which incident light is transmitted. Specifically, as shown in FIG. 15, the liquid crystal layers 3b, 3g. and 3r enter the focal conic state when a pulse voltage of ±24 V (<VF100b) is applied, and the pixel enters a dark state.

When an electric field having an intermediate intensity is applied to a liquid crystal and is thereafter abruptly removed, the liquid crystal enters a state that is a mixture of the planar state and the focal conic state, and an intermediate gray level can be displayed in the state.

Voltage values between voltages VF100b (e.g., 26 V) and VP0 (e.g., 32 V) or voltage values between voltages VF0 (e.g., 6V) and VF100a (e.g., 20 V) are used to display intermediate gray levels. The driving circuits 25 and 27 apply driving pulses to the scan electrodes and data electrodes, respectively, such that pulse voltages having those voltage values will be applied to the liquid crystal. Then, the liquid crystal enters a state of alignment that is a mixture of the planar and focal conic states, and intermediate gray levels can be displayed. When intermediate gray levels are displayed using voltages between the voltages VF0 and VF100a, the intermediate gray levels can be displayed with insignificant irregularities to achieve high display quality, although the operation is limited in that the liquid crystal must be initially in the planar state. When intermediate gray levels are displayed using voltages between the voltages VF100b and VP0, the intermediate gray levels have somewhat more significant irregularities, and it is difficult to exercise control for suppressing crosstalks where general-purpose driver ICs are used. However, the operation is advantageous in that it can be performed with a shorter write time.

To switch a cholesteric liquid crystal from the focal conic state (transparent state) to the planar state (reflective state), a predetermined high voltage VP100 (e.g., 32 V) is applied for a duration ranging from several ms to several tens ms. When a strong electric field is thus generated, the helical structure of the liquid crystal molecules is completely decomposed, and the liquid crystal enters a homeotropic state in which all liquid crystal molecules follow the direction of the electric filed. When the voltage VP100 applied to the liquid crystal is thereafter abruptly decreased to substantially zero, the liquid crystal molecules enters a helical state in which their helical axes are directed substantially perpendicular to the electrodes, and the liquid crystal therefore enters the planar state in which light rays in accordance with the helical pitch of the liquid crystal are selectively reflected.

To switch a cholesteric liquid crystal from the planar state (reflective state) to the focal conic state (transparent state), a predetermined voltage VF100 (e.g., 24 V) between the voltages VP100a and VP100b is applied for a duration ranging from several ms to several tens ms, and the voltage VF100 applied to the liquid crystal is thereafter abruptly decreased to substantially zero. That is, an electric field is generated with such intensity that the helical structure of the liquid crystal molecules is not completely decomposed, and the electric field is thereafter removed.

Thus, the liquid crystal molecules enter a helical state in which their helical axes are directed substantially parallel to the electrodes, and the liquid crystal enters the focal conic state in which incident light is transmitted. Alternatively, the cholesteric liquid crystal can be put in the focal conic state by applying the voltage VP100 to generate a strong electric field in the same and by slowly removing the electric field thereafter.

Intermediate gray levels can be displayed utilizing the curve between the voltages VF0 and VF100a in FIG. 15 representing a transition from the planar state to the focal conic state or the curve between the voltages VF100b and VP0 representing a transition from the focal conic state to the homeotropic state. An arbitrary intermediate density can be obtained by changing at least either of the magnitude or application time of an applied voltage.

The voltage-reflectance characteristics of a cholesteric liquid crystal shown in FIG. 15 are obtained by applying pulse voltages having the same pulse width. Alternatively, cumulative response characteristics of the cholesteric liquid crystal can be obtained by varying the pulse width of the pulse voltages. For example, when two types of pulse voltages having the same voltage value but having different pulse widths are applied within the voltage range between voltages VF0 and VF100a, a lower reflectance can be achieved when the pulse voltage having the greater pulse width is applied than when the pulse voltage having the smaller pulse width is applied.

Image sticking is considered to be an after-image phenomenon attributable to a display density difference caused by changes in the response of a liquid crystal which occur when the planar state (reflective state) continues for a predetermined period and when the focal conic state (transparent state) continues a predetermined period. Such a display density difference is considered to become more significant, the higher the voltage of the driving pulse applied to the liquid crystal, and the shorter the application time of the voltage. It is also considered that such a difference is significant especially when intermediate gray levels are displayed.

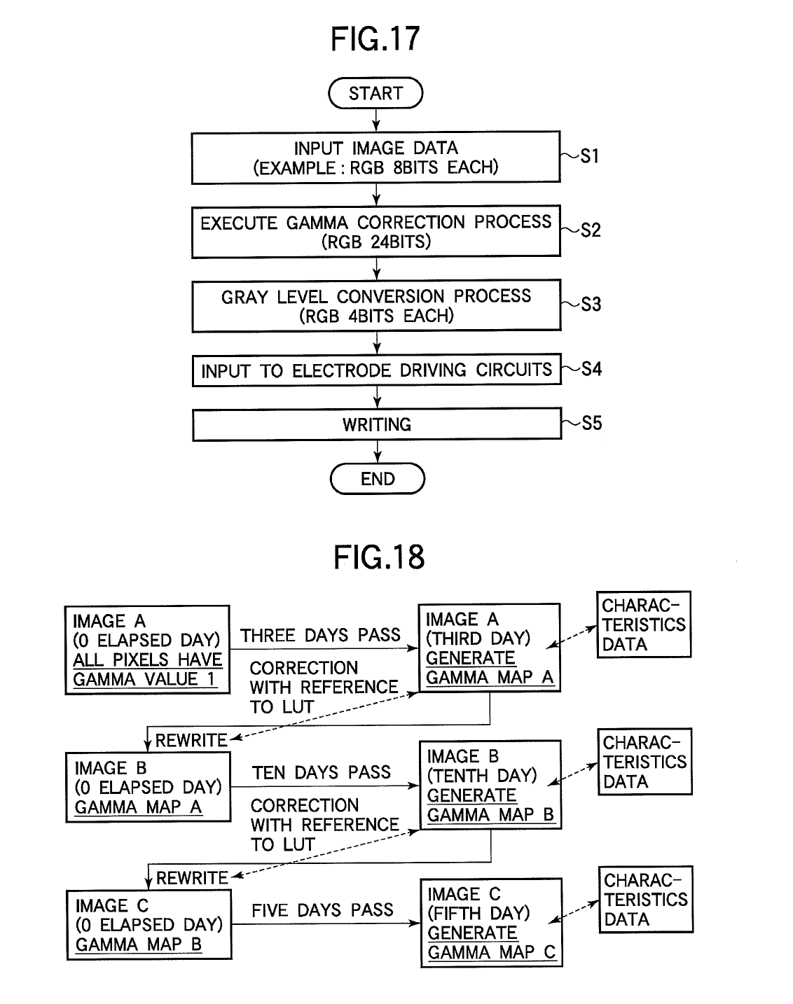

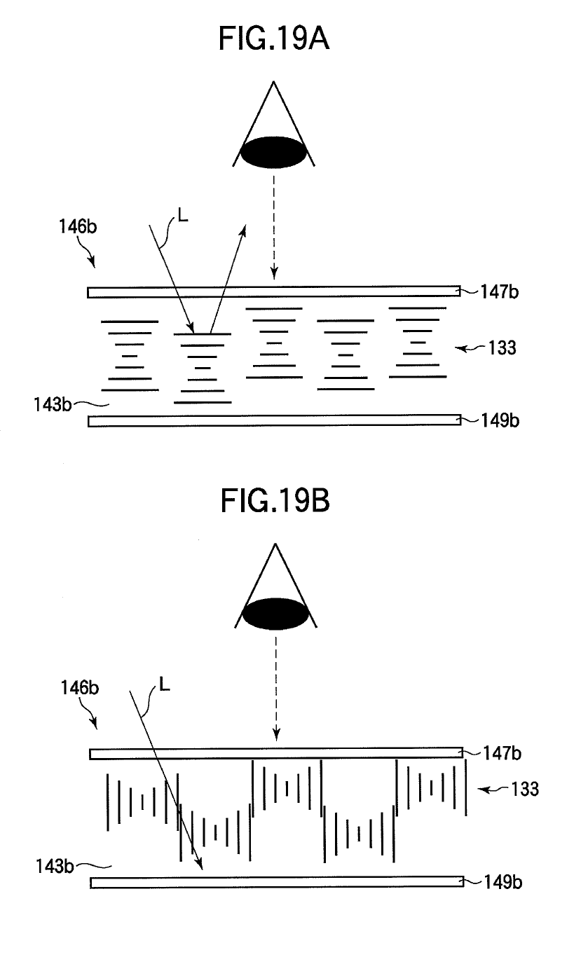

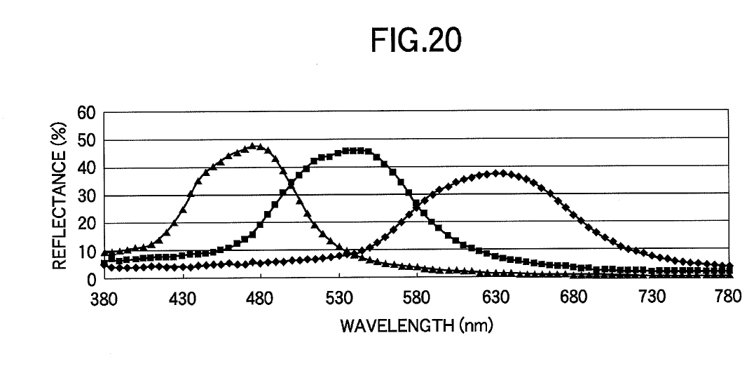

A display processing operation involving a gamma correction process will now be described with reference to FIGS. 13 and 17.

First, image data of a next image to be displayed on the display section 6 are input to the image data storing section 33 from the system to which the liquid crystal display element 1 belongs (step S1). The image data include red, green, and blue data of 8 bits each.

When the image data are input, the control section 30 executes a gamma correction process (step S2). When the gamma correction process is executed, the correction data generating section 40 acquires image sticking determination factor data associated with the previous memorized display image which has been displayed until that time from the image sticking determination factor data generating section 42, and the section 40 also refers to characteristics data acquired from the data storage section 43. The correction data generating section 40 generates correction data based on the image sticking determination factors of the previous image and a predicted value of the degree of image sticking of the same, and the correction data are output to the corrected image data generating section 41. When the correction data are thus acquired, the corrected image data generating section 41 performs a gamma conversion process based on the image data of the next image and the correction data to generate corrected image data. When corrected image data are generated, the corrected image data generating section 41 outputs the corrected image data thus generated to the control section 30. For example, the corrected image data include red, green, and blue data of 24 bits in total (8 bits for each color).

When the corrected image data are acquired, the control section 30 performs a gray level conversion process on the corrected image data (step S3). Thus, the control section 30 converts the corrected image data including red, green, and blue data of 8 bits each into corrected image data including red, green, and blue data of 4 bits each. Further, the control section 30 converts the items of the corrected image data having 4 bits each into driving data based on which the scan electrode driving circuit 25 and the data electrode driving circuit 27 can drive the display section 6. Preferably, the gray level conversion process employs the error diffusion method which allows compensation to be made for conversion errors. In the present embodiment, the gamma correction process is performed prior to the gray level conversion process which provides 4096 gray levels. Alternatively, the gamma correction process may be performed after the gray level conversion process. When the gamma correction process is performed after the gray level conversion process, the process has low correction accuracy because the data have become coarse in that the number of gray levels has been reduced. In order to achieve high correction accuracy, it is preferable to perform the gamma correction process prior to the gray level conversion process in that correction can be performed on image data having a great number of gray levels, e.g., 256 gray levels.

When driving data are obtained by the gray level conversion process, the driving data are input to the scan electrode driving circuit 25 and the data electrode driving circuit 27 by the control section 30 (step S4).

When the driving data is input, the scan electrode driving circuit 25 and the data electrode driving circuit 27 apply voltages to the display section 6 based on the input driving data. Thus, the next image is written and displayed on the display section 6 (step S5). When the next image is displayed on the display section 6, the supply of electric power to most of circuits associated with the display of an image is interrupted as occasion demands. When power supply is interrupted, the liquid crystal display element 1 enters a power save mode in which only the timer 38, the temperature sensor 39, and the corrected image data generating section 41 are driven. Thus, the liquid crystal display element 1 can acquire data required for correction such as the duration of memorized display and a record of temperatures of the display section 6 while the image is displayed on a memorized display basis with power consumption minimized. When another image is input, the liquid crystal display element 1 can correct the image using the data acquired during the period of memorized display, and it is therefore possible to reduce the time required for the image to be displayed on the display section 6.

FIG. 18 schematically shows a gamma correction process performed on an image on the liquid crystal display element 1 when no image has been previously displayed on the display section 6.

When no image has been displayed on the liquid crystal display element 1 such as when the element has just been shipped, the gamma value of the element is set at 1. For this reason, image data of an image A input to the corrected image data generating section 41 does not change before and after correction. The corrected image data generating section 41 therefore outputs the image data to the control section 30 as corrected image data with substantially no correction made on the same. The control section 30 causes the display section 6 to display the image A based on the corrected image data thus acquired. At this time, the image data of the image A output from the corrected image data generating section 41 to the control section 30 are also output to the image sticking determination factor data generating section 42.

Next, the display section 6 is set in an unpowered state, and the image A is kept displayed as a memorized display image for three days, for example. When image data of an image B as a next image to be displayed are input to the image data storing section 33 in this state, the control section 30 causes the correction data generating section 40 to generate correction data.

The correction data generating section 40 acquires image sticking determination factor data including the period of the memorized display of the image A from the image sticking determination factor data generating section 42 and also acquires characteristics data from the data storage section 43. The gamma value has changed at each pixel depending on the gray level of the image A displayed at the pixel and depending on the period of memorized display. The correction data generating section 40 refers to the image sticking determination factor data and the characteristics data thus acquired to generate a gamma map A as correction data. The gamma map A is in the form of an LUT. The correction data generating section 40 outputs the gamma map A to the corrected image data generating section 41. The corrected image data generating section 41 corrects the image data of the image B based on the gamma map A to generate corrected image data for displaying the image B with its display characteristics corrected. Based on the corrected image data of the image B having corrected display characteristics, the control section 30 rewrites the display section 6 having the image A displayed thereon to display the image B on the same. As a result, the image B is displayed on the display section 6 without any after image of the image A attributable to image sticking. At this time, the corrected image data of the image B output from the corrected image data generating section 41 to the control section 30 are also output to the image sticking determination factor data generating section 42.

Next, the display section 6 is set in the unpowered state, and the image B is kept displayed as a memorized display image for ten days, for example. When image data of an image C as a next image to be displayed are input to the image data storing section 33 in this state, the control section 30 causes the correction data generating section 40 to generate correction data.

The correction data generating section 40 acquires image sticking determination factor data including the period of the memorized display of the image B from the image sticking determination factor data generating section 42 and also acquires characteristics data from the data storage section 43. The gamma value has changed at each pixel depending on the gray level of the image B displayed at the pixel and depending on the period of memorized display. The correction data generating section 40 refers to the image sticking determination factor data and the characteristics data thus acquired to generate a gamma map B as correction data. The gamma map B is in the form of an LUT. The correction data generating section 40 outputs the gamma map B to the corrected image data generating section 41. The corrected image data generating section 41 corrects the image data of the image C based on the gamma map B to generate corrected image data for displaying the image C with its display characteristics corrected. Based on the corrected image data of the image C having corrected display characteristics, the control section 30 rewrites the display section 6 having the image B displayed thereon to display the image C on the same. As a result, the image C is displayed on the display section 6 without any after image of the image B attributable to image sticking. At this time, the corrected image data of the image C output from the corrected image data generating section 41 to the control section 30 are also output to the image sticking determination factor data generating section 42.

Similarly, the display section 6 is set in the unpowered state, and the image C is kept displayed as a memorized display image for five days, for example. When image data of an image to be displayed next are input to the image data storing section 33 in this state, the control section 30 causes the correction data generating section 40 to generate correction data.

The correction data generating section 40 acquires image sticking determination factor data including the period of the memorized display of the image C from the image sticking determination factor data generating section 42 and also acquires characteristics data from the data storage section 43. The gamma value has changed at each pixel depending on the gray level of the image C displayed at the pixel and depending on the period of memorized display. The correction data generating section 40 refers to the image sticking determination factor data and the characteristics data thus acquired to generate a gamma map C as correction data. The gamma map C is in the form of an LUT. Thereafter, processes similar to those performed as described above for rewriting the display section 6 to display the image B or image C are performed.

In the liquid crystal display element 1 of the present embodiment, image data of an image to be displayed next are corrected so as to cancel changes in gamma characteristics attributable to image sticking at the display section 6, and the next image is displayed using corrected image data obtained by the correction. As a result, in the liquid crystal display element 1, an after image attributable to image sticking can be prevented without interrupting display of an image by performing a refreshing operation or the like. Therefore, any degradation of display quality attributable to image sticking can be prevented on the liquid crystal display element 1 while maintaining a memorized state of display.

While the invention has been described based on an embodiment of the same, the invention is not limited to the above-described embodiment and may be modified in various ways.

While the display section 6 of the above-described embodiment employs a display method utilizing cholesteric liquid crystals, the invention is not limited such a method. The display section may employ other display methods including memory characteristics such as electrophoretic methods and methods involving a twist ball.

In the above-described embodiment, display characteristic of an image to be displayed next are corrected based on image sticking determination factors of an image which is presently displayed. The invention is not limited to such a mode of correction, and correction may be made based on image sticking determination factors of a past image which has been displayed prior to the presently displayed image.

Further, while the above embodiment has been described as a liquid crystal display element 1 having a three-layer structure formed by display portions 6b, 6g, and 6r by way of example, the invention is not limited to such a structure and may be applied to liquid crystal display elements having structures including one layer, two layers, or four or more layers.

Since degradation of display quality attributable to image sticking can be prevented while maintaining a memorized state of display, the invention can be advantageously used in various display elements including a display section having memory characteristics.

What is claimed is:

1. A display device comprising:
a display section displaying a memorized display image which is kept displayed without electric power;
a correction data generating section generating correction data for correcting a display characteristic of the display section which has changed due to sticking of the memorized display image;
a corrected image data generating section generating corrected image data by correcting image data of a next image to be displayed next on the display section using the correction data; and
a display control section causing the display section to display the next image according to the corrected image data.

2. The display device according to claim 1, wherein the correction data are generated to cancel the amount of a change in the display characteristic.

3. The display device according to claim 2, wherein the correction data generating section acquires a predicted value of the degree of image sticking by referring to characteristics data in which an image sticking determination factor used for determining the degree of sticking of the memorized display image is associated with a predicted value of the degree of image sticking, the correction data generating section calculating the amount of a change from the acquired predicted value.

4. The display device according to claim 1, wherein the display characteristic is a gray level curve.

5. The display device according to claim 4, wherein the corrected image data are generated such that gray level curves of a plurality of pixels formed at the display section become substantially the same.

6. The display device according to claim 3, wherein a period during which the memorized display image has been displayed is used as the image sticking determination factor.

7. The display device according to claim 3, wherein a record of the temperature of the display section measured when displaying the memorized display image is used as the image sticking determination factor.

8. The display device according to claim 3, wherein a gray level of the memorized image displayed is used as the image sticking determination factor.

9. The display device according to claim 1, wherein the corrected image data are generated prior to a gray level conversion process for converting the number of bits of the image data.

10. The display device according to claim 1, wherein the display section includes a liquid crystal which forms a cholesteric phase.

11. A method of driving a display device, comprising the steps of:
displaying a memorized display image which is kept displayed on the display section without electric power;
generating correction data for correcting a display characteristic of the display section which has changed due to sticking of the memorized display image;
generating corrected image data by correcting image data of a next image to be displayed next on the display section using the correction data; and
displaying the next image on the display section according to the corrected image data.

12. The method according to claim 11, wherein the correction data are generated to cancel the amount of a change in the display characteristic.

13. The method according to claim 12, further comprising the steps of:
acquiring a predicted value of the degree of image sticking by referring to characteristics data in which an image sticking determination factor used for determining the degree of sticking of the memorized display image is associated with a predicted value of the degree of image sticking; and
calculating the amount of a change from the acquired predicted value.

14. The method according to claim 11, wherein the display characteristic is a gray level curve.

15. The method according to claim 14, wherein the corrected image data are generated such that gray level curves of a plurality of pixels formed at the display section become substantially the same.

16. The method according to claim 13, wherein a period during which the memorized display image has been displayed is used as the image sticking determination factor.

17. The method according to claim 13, wherein a record of the temperature of the display section measured when displaying the memorized display image is used as the image sticking determination factor.

18. The method according to claim 13, wherein a gray level of the memorized image displayed is used as the image sticking determination factor.

19. The method according to claim 11, wherein the corrected image data are generated prior to a gray level conversion process for converting the number of bits of the image data.

20. The method according to claim 11, wherein the display section includes a liquid crystal which forms a cholesteric phase for displaying the memorized display image.
